(19) United States
(12) Patent Application Publication
(10) Pub. No.: US 2024/0424694 A1
(43) Pub. Date: Dec. 26, 2024

(54) Highly Articulate Snake Robotic Device

(71) Applicant: Georgia Tech Research Corporation, Atlanta, GA (US)

(72) Inventors: Stephen Balakirsky, Atlanta, GA (US); Konrad Ahlin, Atlanta, GA (US)

(21) Appl. No.: 18/689,939

(22) PCT Filed: Sep. 8, 2022
(86) PCT No.: PCT/US2022/076093

§ 371 Date: Mar. 7, 2024

Related U.S. Application Data
(60) Provisional application No. 63/242,136, filed on Sep. 9, 2021.

(51) Int. Cl. B25J 18/06; B25J 9/06; B25J 13/08; B25J 17/00

(52) U.S. Cl. CPC B25J 18/06; B25J 9/065; B25J 13/087; B25J 17/00

(57) ABSTRACT

An exemplary embodiment of the present disclosure provides a snake robotic device that can comprise a flexible member, one or more actuators. one or more tendons, and a controller. The flexible member can comprise a proximal end and a distal end. The one or more actuators can be configured to maneuver at least a portion of the flexible member. The one or more tendons each can comprise a first end connected to an actuator in the one or more actuators and a second end connected to a distinct portion of the flexible member, such that actuation of the one or more actuators can cause a resulting movement in the flexible member. The controller can be configured to transmit at least one control signal to the one or more actuators.

### CROSS-REFERENCE TO RELATED APPLICATIONS

This application claims the benefit of U.S. Provisional Application Ser. No. 63/242,136, filed on 9 Sep. 2021, which is incorporated herein by reference in its entirety as if fully set forth below.

### FIELD OF THE DISCLOSURE

The various embodiments of the present disclosure relate generally to highly articulate snake robots.

### BACKGROUND

Snake robots exist in numerous forms. The disadvantages of current snake robots, however, is that they are either too rigid or not fully actuated, typically relying on walls or supports to guide them. These disadvantages cause current snake robotic designs to be limited in their capability to be agile within constrained environments or in the presence of obstacles. Consequently, current snake robotic devices, due to the aforementioned limitations, cannot be scaled for utilization in scenarios or mission sets disposed in constrained environments. Accordingly, there is a need for providing a highly articulate snake robotic device that is both flexible and controllable, relying on custom controlled path planning algorithms to operate within constrained environments.

### BRIEF SUMMARY

An exemplary embodiment of the present disclosure provides a snake robotic device that can comprise a flexible member, one or more actuators, one or more tendons, and a controller. The flexible member can comprise a proximal end and a distal end. The one or more actuators can be configured to maneuver at least a portion of the flexible member. The one or more tendons each can comprise a first end connected to an actuator in the one or more actuators and a second end connected to a distinct portion of the flexible member, such that actuation of the one or more actuators can cause a resulting movement in the flexible member. The controller can be configured to transmit at least one control signal to the one or more actuators.

In any of the embodiments disclosed herein, the flexible member can comprise one or more joints located at the distinct portions of the flexible member, each of the joints coupled to the second end of a respective tendon of the one or more tendons.

In any of the embodiments disclosed herein, the one or more joints can comprise a first joint and a second joint, the first joint having at least one aperture wherein a first tendon in the one or more tendons passes through the aperture of the first joint and a second end of the first tendon is coupled to the second joint.

In any of the embodiments disclosed herein, the second end of a second tendon in the one or more tendons can be coupled to the first joint.

In any of the embodiments disclosed herein, the flexible member can include an interior chamber spanning at least a portion of a length of the flexible member, wherein the one or more joints are located within the interior chamber.

In any of the embodiments disclosed herein, the snake robotic device can further comprise a support structure wherein the proximal end of the flexible member can be coupled to the support structure.

In any of the embodiments disclosed herein, wherein one or more actuators can be located proximate the support structure.

In any of the embodiments disclosed herein, the support structure can comprise an actuator bank, wherein the actuator bank can house one or more actuators.

In any of the embodiments disclosed herein, the proximal end of the flexible member can be connected to the actuator bank.

In any of the embodiments disclosed herein, the actuator bank can be configured to move along the support structure.

In any of the embodiments disclosed herein, the flexible member can comprise an interior chamber spanning at least a portion of a length of the flexible member, wherein at least a portion of the one or more actuators are located within the interior chamber.

In any of the embodiments disclosed herein, the flexible member can comprise one or more sensors configured to monitor a condition within a physical environment in which the distal end of the flexible member can be located.

In any of the embodiments disclosed herein, the one or more sensors can be further configured to collect a sample within the physical environment in which the distal end of the flexible member can be located.

In any of the embodiments disclosed herein, the flexible member can be further configured to deform in response to at least a portion of the flexible member colliding with at least a portion of a physical environment in which the flexible member can be located.

Another embodiment of the present disclosure provides a snake robotic device that can comprise a support structure, a flexible member, one or more actuators, one or more joints, one or more tendons, and a controller. The flexible member can comprise a proximal end and a distal end, the proximal end can be coupled to the support structure and the distal end can be configured to interact with a physical environment. The one or more actuators can be configured to maneuver at least a portion of the flexible member. The one or more joints can be located at distinct portions of the flexible member. Each of the one or more tendons can comprise a first end connected to a distinct actuator in the one or more actuators and a second end connected to a joint of the flexible member, such that actuation of the one or more actuators can cause a resulting movement in the flexible member. The controller can be configured to transmit at least one control signal to the one or more actuators.

In any of the embodiments disclosed herein, the one or more joints can comprise a first joint having one or more apertures, wherein a first tendon in the one or more tendons passes through a first aperture in the one or more apertures.

In any of the embodiments disclosed herein, the one or more joints can comprise a second joint wherein a second end of the first tendon can be coupled to the second joint.

In any of the embodiments disclosed herein, a second end of a third tendon can be coupled to the first joint.

In any of the embodiments disclosed herein, the snake robotic device can further comprise at least one sensor that can be configured to transmit a signal via a sensor control line, wherein the sensor control line passes through a third aperture in the one or more apertures.

In any of the embodiments disclosed herein, the one or more joints can comprise a first joint, wherein a second end of a first tendon of the one or more tendons can be coupled to a first location on the first joint, and wherein a second end of a second tendon can be coupled to a second location on the first joint, such that actuation of the first tendon can cause the flexible member to move in a first direction and actuation of the second tendon can cause the flexible member to move in a second direction.

In any of the embodiments disclosed herein, the one or more joints can be located within an interior chamber of the flexible member.

In any of the embodiments disclosed herein, the one or more actuators can be located within an interior chamber of the flexible member.

In any of the embodiments disclosed herein, the snake robotic device can further comprise an actuator bank housing the one or more actuators.

In any of the embodiments disclosed herein, the proximal end of the flexible member can be coupled to the support structure indirectly via the actuator bank.

In any of the embodiments disclosed herein, the actuator bank can be movable along the support structure.

In any of the embodiments disclosed herein, the support structure can comprise a spool that can comprise an inner diameter and an outer diameter that can be configured to wind circumferentially about the inner diameter and receive at least a portion of the flexible member disposed circumferentially about the outer diameter.

In any of the embodiments disclosed herein, the spool can be further configured to deploy at least a portion of the flexible member disposed circumferentially about the outer diameter by rotating circumferentially about the inner diameter.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 shows a computer aided design (CAD) illustration of an exemplary snake robotic device. The illustration shows the orientation of the snake robotic device in the proximal and distal direction with respect to the flexible member, support structure, actuator bank, and joints, in accordance with an exemplary embodiment of the present disclosure.

FIG. 2 shows an illustration of a flexible member of an exemplary snake robotic device receiving a control signal from a controller transmitted to the one or more actuators therein causing a resulting movement in the flexible member due to a displacement of one or more tendons coupled to one or more joints along the flexible member.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

By “comprising” or “containing” or “including” is meant that at least the named compound, element, particle, or method step is present in the composition or article or method, but does not exclude the presence of other compounds, materials, particles, method steps, even if other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

Within the current market of robotics, there has become an emerging need for robotic devices capable of highly dexterous manipulation in the presence of constrained physical environments containing obstacles. The advantage of a device capable of navigating constrained physical environments could enable users to interact, sense or monitor conditions within environments where humans or traditional robotic devices may be incapable of reaching. Traditional rigid robotic devices, also known as manipulators, although capable of some degree of navigation within constrained physical environments, typically utilize walls or obstacles to support themselves. Additionally, rigid manipulators are not specifically designed to actuate in response to potential collisions with unexpected obstacles within physical environments, as these collisions could result in damage compromising the operational capability of said manipulator. The devices, described herein, can allow for advantages such as a “hyper redundant” design, allowing for a multitude of joints capable of actuated bending and separating actuation from the manipulator body, a flexible body, reducing the concern of collisions with obstacles within a physical environment damaging operational capability of the device, scalability of design, enabling the device to be repurposed for varying applications.

In some embodiment of the present disclosure, a snake robotic device (100) can include the following elements: a flexible member (200) that can comprise a proximal end (20) and a distal end (30), one or more actuators (400) that can be configured to maneuver at least a portion of the flexible member (200), one or more tendons (600) wherein each of the one or more tendons (600) can comprise a first end connected to an actuator in the one or more actuators (400) and a second end connected to a distinct portion of the flexible member (200) such that actuation of the one or more actuators (400) causes a resulting movement in the flexible member (200), and a controller (700) that can be configured to transmit at least one control signal to the one or more actuators (400).

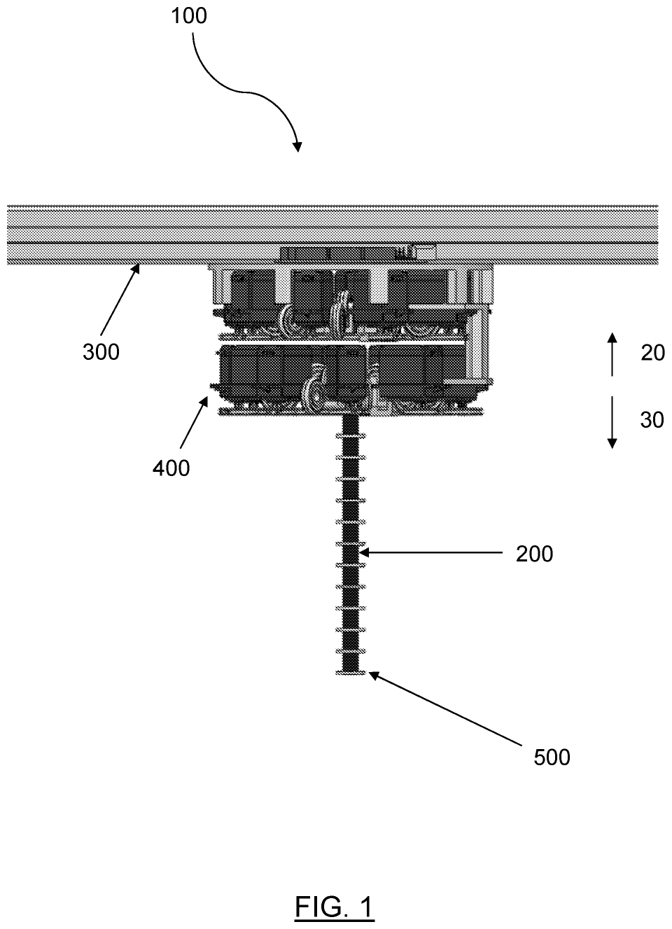

FIG. 1 illustrates a computer aided design (CAD) design of an exemplary snake robotic device (100) described within the present disclosure. The snake robotic device (100) can further comprise a support structure (300). The support structure (300) can comprise an actuator bank housing the one or more actuators (400). As illustrated in FIG. 1, the proximal end (20) of the flexible member (200) can be coupled to the support structure (300) via an actuator bank, housing the one or more actuators (400). The actuator bank, housing the one or more actuators (400), can be configured to move along the support structure which can enable the highly articulate snake robotic device (100) to move within a physical environment in which it is deployed.

As one who is skilled in the art will appreciate, some embodiments of the present disclosure differ from traditional robotic manipulators in that they can separate actuation functionality from the manipulator body. A manipulator is an arm-like robotic structure coupled to a rigid body and can be used to execute a specified task. In traditional manipulators, actuators are located within the body of the manipulator, impacting the degrees of freedom that the device can move. In contrast to these traditional devices, some exemplary snake robotic devices (100) described in the present disclosure can have increased degrees of freedom of flexibility due to disposing the one or more actuators (400), housed in an actuator bank, proximate to the support structure (300). Additionally, the flexible member (200) can further comprise an inner chamber, spanning at least a portion of a length of the flexible member (200), wherein one or more joints (500) can be located at distinct locations of the flexile member (200) body within said interior chamber. The hyper redundant design of the claimed invention can allow for the addition of one or more joints (500) to the interior chamber of the flexible member (200), which can increase the degree of freedom of flexibility for the snake robotic device (100).

In addition to navigating a constrained physical environment, in some embodiments, the snake robotic device (100) can monitor a condition within said physical environment through use of an end effector or sensors. In some embodiments, the flexible member (200) can further comprise one or more sensors that can be configured to monitor a condition within a physical environment in which the distal end (30) of the flexible member (200) can be located. The one or more sensors can also be further configured to collect a sample within the physical environment in which the distal end (30) of the flexible member (200) can be located. As one who is skilled in the art can appreciate there are various types of end effectors or sensors that can be used to monitor conditions and take samples within a physical environment. Examples of possible end effectors or sensors that can be used with the snake robotic device (100) can include but are not limited to a camera, microscope, biopsy probe, chemical sensor, temperature sensor, color sensor, motion sensors, and the like. In some embodiments, the snake robotic device (100) could be used within a bioreactor wherein the distal end (30) of the flexible member (200) can be equipped with an appropriate end effector or sensor to monitor and measure growing tissue. The sample could be collected by the distal end (30) of the flexible member (200) wherein the operator of the robotic device can retrieve the sample and other discrete data retrieved by the one or more sensors and end effector.

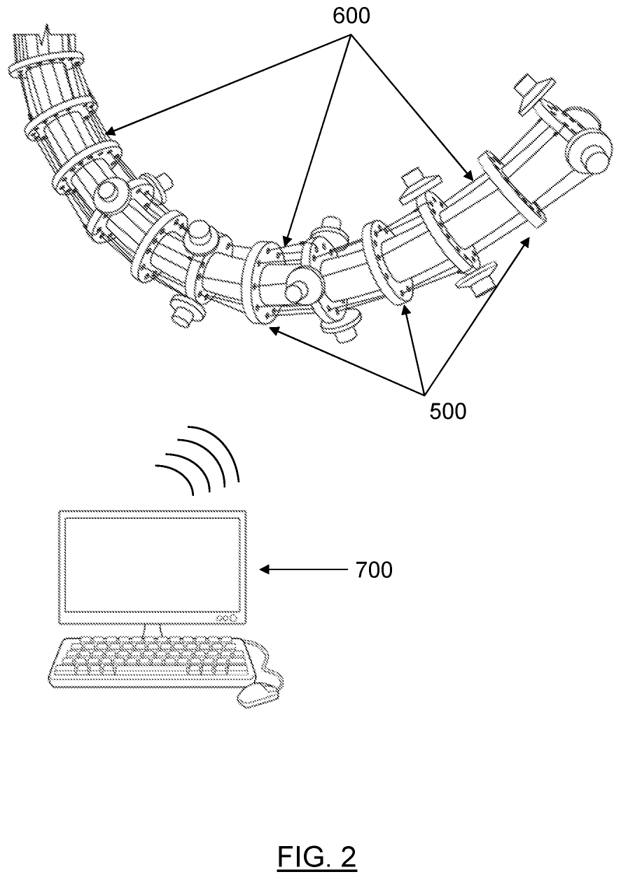

FIG. 2 illustrates a detailed view of the flexible member (200) receiving a control signal from the controller (700) transmitted to the one or more actuators (400), housed within the actuator bank, therein resulting in a movement of the flexible member (200). The movement of the flexible member can be caused in part due to the movement of (or application of a tensile force by the actuators to) the one or more tendons (600). The one or more joints (500) can comprise a first joint and a second joint. The first joint of the one or more joints (500) can have at least one aperture wherein a first tendon of the one or more tendons (600) passes through the aperture of the first joint and a second end of the first tendon can be coupled to the second joint. To create a resulting movement in the flexible member (200), the controller (700) can transmit at least one control signal to the one or more actuators (400) housed in the actuator bank disposed proximate to the support structure (300) (or disposed within a chamber of the flexible member (200)). As one who is skilled in the art will appreciate, the controller (700) can transmit the at least one control signal that the one or more actuators (400) can receive using some medium of interconnectivity. Examples of mediums of interconnectivity relating to the claimed invention that can enable the capability to transmit and receive control signals can include but are not limited to cloud based networks, wired networks, wireless (Wi-Fi) networks, Bluetooth networks, and the like.

Upon reception of the control signal, the one or more actuators can alter the length of at least one tendon in the one or more tendons (600) from the second end of the one at least one tendon to the one or more actuators (400), housed in the actuator bank (or disposed within a chamber of the flexible member (200)). By altering the length of at least one tendon in the one or more tendons (600), the flexible member (200) can move in a direction corresponding to the change in length of the at least one tendon in the one or more tendons (600). In addition to actuation of the flexible member (200) by a combination of the one or more tendons (600) and the one or more actuators (400), the flexible member (200) can be further configured to deform in response to at least a portion of the flexible member (200) colliding with at least a portion of the physical environment in which the flexible member (200) can be located.

In some embodiments of the snake robotic device (100), each joint of the one or more joints (500), disposed at distinct locations within the inner chamber of the flexible member (200), can comprise one or more apertures. Each tendon of the one or more tendons (600) can comprise a first end connected to a distinct actuator in the one or more actuators (400) and a second end connected to a joint of the one or more joints (500). A first tendon in the one more tendons (600) can pass through a first aperture in the one or more apertures on a first joint of the one or more joints (500). A second tendon in the one or more tendons (600) can pass through a second aperture in the one or more apertures. The one or more joints (500) can comprise a second joint wherein the second end of the first tendon can be coupled to said second joint. A second end of a third tendon can be coupled to the first joint of the one or more joints (500). The snake robotic device (100) can further comprise at least one sensor, coupled to the flexible member (200), that can be configured to transmit a signal via a sensor control line that can pass through a third aperture in the one or more apertures. As illustrated FIG. 2, each of the second ends of the tendons of the one or more tendons (600) can either terminate at a distinct location on the one or more joints (500) or can pass through the aperture of the one or more apertures on the one or more joints (500). Therefore, the snake robotic device (100) can move in part through actuation of a distinct actuator of the one or more actuators (400) that can be coupled to the first end of a distinct tendon of the one or more tendons (600).

In some embodiments, the one or more joints (500) can comprise a first joint wherein a second end of a first tendon of the one or more tendons (600) can be coupled to a first location of the first joint and the first end of said first tendon can be connected to a distinct actuator of the one or more actuators (400). A second end of a second tendon can be coupled to a second location on the first joint and the first end of said second tendon can be connected to a distinct actuator of the one or more actuators (400). The flexible member (200) can then move in a first direction that can be caused by actuation of the first tendon of the one or more tendons (600). The flexible member (200) can then move in a second direction that can be caused by actuation of the second tendon of the one or more tendons (600).

As discussed previously, in some embodiments, the snake robotic device (100) can be scaled in size based on the application or physical environment where it can be deployed. For the purposes of explanation, the utility of the snake robotic device (100) is discussed in the context of inspecting a ballast tank. Ancient vessels used solid material ballast, such as rocks, iron, sandbags, and the like, and placed the solid ballast at strategic locations of the vessel to maintain stability and seaworthiness. Modern vessels use liquid ballast, such as brackish water, seawater, freshwater, and the like, for the same purpose as ancient vessels. Based on the size of the ship, multiple ballast tanks can be placed within the ship at distinct locations. The ballast tanks of modern vessels can become highly corrosive environments, warranting inspection to ensure integrity of the ballasts. These inspections could be conducted during, before or after voyages and can be conducted with the claimed invention described herein.

In some embodiments, the support structure (300) of the snake robotic device (100) can comprise a spool that can comprise an inner diameter and an outer diameter. The outer diameter can be configured to wind circumferentially about said inner diameter and can receive at least a portion of the flexible member (200) disposed circumferentially about the outer diameter. The spool can be further configured to deploy at least a portion of the flexible member (200) disposed circumferentially about the outer diameter by rotating circumferentially about the inner diameter. The embodiment of the highly articulate snake robotic device (100) described herein can be applied to inspections of ballast tanks. Specifically, the flexible member (200) can be deployed into the ballast tank through use of the spool with the proximal end (20) coupled to the spool of the support structure (300). The distal end (30) of the flexible member (200) can be used to monitor conditions and sample the physical environment within the ballast tank via the end effector and one or more sensors that can be coupled to the flexible member (200).

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. A snake robotic device comprising:
a support structure comprising an actuator bank;
a flexible member comprising a proximal end coupled to the support structure and a distal end;
one or more actuators housed in the actuator bank and configured to maneuver at least a portion of the flexible member;
one or more tendons, each of the one or more tendons comprising a first end connected to an actuator in the one or more actuators and a second end connected to a distinct portion of the flexible member, such that actuation of the one or more actuators causes a resulting movement in the flexible member; and
a controller configured to transmit at least one control signal to the one or more actuators;
wherein the provision of the actuator bank separate from the flexible member provides for degrees of freedom of flexibility for the snake robotic device dependent upon any number of actuators.

2. The snake robotic device of claim 1, wherein the flexible member comprises one or more joints located at the distinct portions of the flexible member, each of the joints coupled to the second end of a respective tendon of the one or more tendons.

3. The snake robotic device of claim 2, wherein the one or more joints comprise a first joint and a second joint, the first joint having at least one aperture, wherein a first tendon in the one or more tendons passes through the aperture of the first joint and a second end of the first tendon is coupled to the second joint.

4. The device of claim 3, wherein the second end of a second tendon in the one or more tendons is coupled to the first joint.

5. The device of claim 2, wherein the flexible member comprises an interior chamber spanning at least a portion of a length of the flexible member, wherein the one or more joints are located within the interior chamber.

6-9. (canceled)

10. The device of claim 1, wherein the actuator bank is configured to move along the support structure.

11. The device of claim 1, wherein the flexible member comprises an interior chamber spanning at least a portion of a length of the flexible member, wherein at least a portion of the one or more actuators are located within the interior chamber.

12. The device of claim 1, wherein the flexible member comprises one or more sensors configured to monitor a condition within a physical environment in which the distal end of the flexible member is located.

13. The device of claim 12, wherein the one or more sensors is further configured to collect a sample within the physical environment in which the distal end of the flexible member is located.

14. The device of claim 1, wherein the at least one control signal transmitted by the controller to the one or more actuators causes the one or more actuators to alter a length of at least one tendon in the one or more tendons from the second end of the at least one tendon to the one or more actuators.

15. The device of claim 1 wherein the flexible member is further configured to deform in response to at least a portion of the flexible member colliding with at least a portion of a physical environment in which the flexible member is located.

16. A snake robotic device comprising:
a support structure comprising one or more actuators;
a flexible member comprising a proximal end and a distal end, the proximal end coupled to the support structure, the distal end configured to interact with a physical environment;
one or more joints located at distinct portions of the flexible member;
one or more tendons, each of the one or more tendons comprising a first end connected to a distinct actuator in the one or more actuators and a second end connected to a joint of the flexible member, such that actuation of the one or more actuators causes a resulting movement in the flexible member; and
a controller configured to transmit at least one control signal to the one or more actuators;
wherein the one or more actuators are configured to maneuver at least a portion of the flexible member; and
wherein provision of the actuators separate from the flexible member provides for degrees of freedom of flexibility for the snake robotic device dependent upon any number of actuators.

17. The device of claim 16, wherein the one or more joints comprises a first joint having one or more apertures, wherein a first tendon in the one or more tendons passes through a first aperture in the one or more apertures.

18. The device of claim 17, wherein a second tendon in the one or more tendons passes through a second aperture in the one or more apertures.

19. The device of claim 18, wherein the one or more joints comprises a second joint, wherein a second end of the first tendon is coupled to the second joint.

20. (canceled)

21. The device of claim 17 further comprising at least one sensor coupled to the flexible member, the at least one sensor configured to transmit a signal via a sensor control line, wherein the sensor control line passes through a third aperture in the one or more apertures.

22. The device of claim 16, wherein the one or more joints comprises a first joint, wherein a second end of a first tendon of the one or more tendons is coupled to a first location on the first joint, and wherein a second end of a second tendon is coupled to a second location on the first joint, such that actuation of the first tendon causes the flexible member to move in a first direction and actuation of the second tendon causes the flexible member to move in a second direction.

23. A snake robotic device of comprising:
a support structure comprising actuators and a spool;
a flexible member comprising a proximal end and a distal end, the proximal end coupled to the support structure, the distal end configured to interact with a physical environment;
joints located at distinct portions of the flexible member and within an interior chamber of the flexible member, each joint comprising apertures;
tendons, each tendon comprising a first end connected to a respective actuator of the actuators and a second end connected to a respective joint of the joints, such that actuation of the respective actuator causes resulting movements in the flexible member via actuation of the respective joint;
a controller configured to transmit control signals to the actuators; and
at least one sensor coupled to the flexible member and configured to transmit a signal via a sensor control line, wherein each sensor control line passes through a respective aperture the joints;
wherein each tendon passes through a respective aperture of each joint positioned between a respective actuator and the respective joint to which the tendon is connected;
wherein the spool comprises an inner diameter and outer diameter configured to wind circumferentially about the inner diameter and receive at least a portion of the flexible member disposed circumferentially about the outer diameter;
wherein the spool is further configured to deploy at least a portion of the flexible member disposed circumferentially about the outer diameter by rotating circumferentially about the inner diameter; and
wherein provision of the actuators in the support structure separate from the flexible member provides for degrees of freedom of flexibility for the snake robotic device dependent upon any number of actuators.

24. (canceled)

25. The device of claim 23 further comprises an actuator bank housing the one or more actuators.

26. The device of claim 25, wherein the proximal end of the flexible member is coupled to the support structure indirectly via the actuator bank.

27-29. (canceled)
